(19) United States
(12) Patent Application Publication
(10) Pub. No.: US 2016/0231518 A1
(43) Pub. Date: Aug. 11, 2016

(54) OPTICAL COUPLING AND ASSEMBLY

(71) Applicants: Russell K. STILES, Lisle, IL (US); Roger KOUMANS, Lisle, IL (US); David W. WHITNEY, Lisle, IL (US); MOLEX INCORPORATED, Lisle, IL (US)

(72) Inventors: Russell K. STILES, Downers Grove, IL (US); Roger KOUMANS, Irvine, CA (US); David W. WHITNEY, Santa Rosa, CA (US)

(73) Assignee: Molex, LLC, Lisle, IL (US)

(21) Appl. No.: 15/027,792

(22) PCT Filed: Oct. 14, 2014
(86) PCT No.: PCT/US2014/060434

§ 371 Date: Apr. 7, 2016

Related U.S. Application Data
(60) Provisional application No. 61/890,541, filed on Oct. 14, 2013.

(51) Int. Cl. G02B 6/42; G02B 6/26

(52) U.S. Cl. CPC G02B 6/4214; G02B 6/4206; G02B 6/262; G02B 6/4212; G02B 6/4255

(57) ABSTRACT

An optical interconnect assembly includes an optical coupling component having a body formed of a polymer material. The body has a reflecting surface defining a first focal point and a second focal point, a first focal surface generally aligned with the first focal point, and a second focal surface generally aligned with the second focal point. The first focal surface and the second focal surface are spaced apart and at an angle to each other, and an optical path extends through the body from the first focal point to the reflecting surface and to the second focal point. An optical source from which a light signal is transmitted is positioned adjacent the first focal surface and an optical target at which the light signal is received is positioned adjacent the second focal surface.

### REFERENCE TO RELATED APPLICATIONS

The Present Disclosure claims priority to prior-filed U.S. Provisional Patent Application No. 61/890,541, entitled “Athermal Optical Geometry For Fiber Coupling,” filed on 14 Oct. 2013 with the United States Patent And Trademark Office. The content of the aforementioned Patent Application is incorporated in its entirety herein.

### BACKGROUND OF THE PRESENT DISCLOSURE

The Present Disclosure relates generally to optical assemblies and, more particularly, to an optical coupling component and assembly in which changes in temperature have a reduced operational impact.

A significant issue when using polymer optics is the performance of the optical system over temperature. For example, optic components made from polymers have fundamental properties inherent to the material, such as, changes in Refractive Index with temperature (dN/dT) and coefficients of thermal expansion (CTE), that are typically ten times larger than glass or electronic substrates and glass filled polymers to which they are attached. These fundamental properties limit the use of polymer optical components in many fiber optic connection applications.

In some applications, the large dN/dT and CTE properties may generate a change in focused light position that results in a degradation of performance of the optical connection over temperature. This degradation of performance limits and sometimes prevents the use of polymer optic components in many fiber optic applications. In some instances, single mode fiber optic applications may be especially susceptible to degradation of performance due to the effects of changes in temperature.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY OF THE PRESENT DISCLOSURE

In one aspect, an optical interconnect assembly includes an optical coupling component having a body formed of a polymer material. The body has an ellipsoidal reflecting surface defining a first focal point and a second focal point, a first focal surface generally aligned with the first focal point, and a second focal surface generally aligned with the second focal point. The first focal surface and the second focal surface are spaced apart and at an angle to each other, and an optical path extends through the body from the first focal point to the reflecting surface and to the second focal point. An optical source from which a light signal is transmitted is positioned adjacent the first focal surface and an optical target at which the light signal is received is positioned adjacent the second focal surface.

In another aspect, an optical coupling component for optically coupling a first optical component to a second optical component includes a body formed of a polymer material. The body has an ellipsoidal reflecting surface defining a first focal point and a second focal point, a first focal surface aligned with the first focal point and a second focal surface aligned with the second focal point. The first focal surface and the second focal surface are spaced apart and at an angle to each other and an optical path extends through the body from the first focal point to the reflecting surface and to the second focal point.

In still another aspect, an optical interconnect assembly includes an optical coupling component having a body formed of a polymer material. The body has a reflecting surface defining a first focal point and a second focal point, a first focal surface generally aligned with the first focal point, and a second focal surface generally aligned with the second focal point. The first focal surface and the second focal surface are spaced apart and at an angle to each other and an optical path extends through the body from the first focal point to the reflecting surface and to the second focal point. An optical source is positioned adjacent the first focal surface and an optical target is positioned adjacent the second focal surface.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a schematic illustration of an optical coupling system according to the disclosure;

FIG. 2 is a perspective view of an optical coupling system according to the disclosure;

FIG. 3 is a perspective view similar to FIG. 2 but taken from a different perspective;

FIG. 4 is a section of the optical coupling system taken generally along line 4-4 in FIG. 2;

FIG. 5 is a perspective view of an alternate embodiment of an optical coupling system with optical fibers coupled to the coupling component;

FIG. 6 is a perspective view of another alternate embodiment of an optical coupling system with an emitter and a detector coupled to the coupling component; and

FIG. 7 is a schematic illustration of an alternate embodiment of the coupling component of the optical coupling system.

### DETAILED DESCRIPTION

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, forward and rearward, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

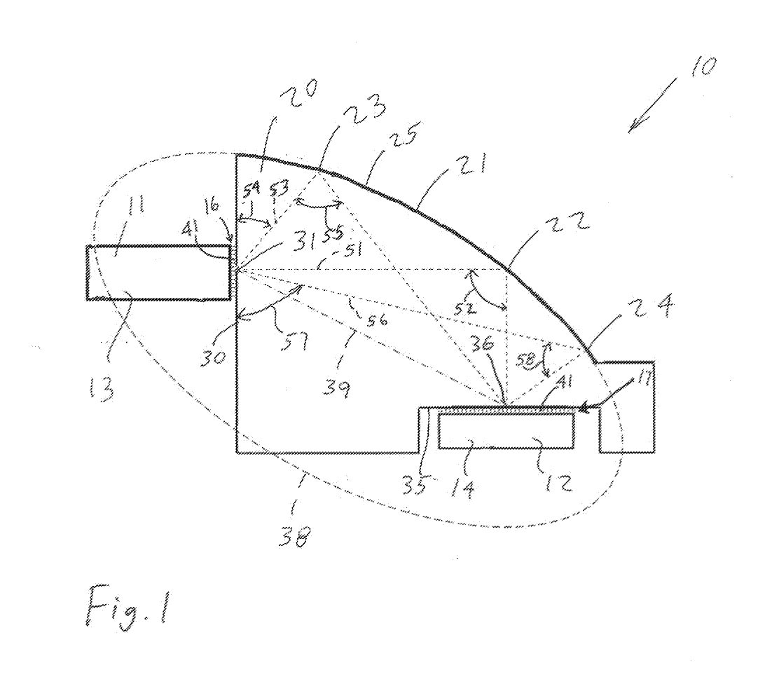

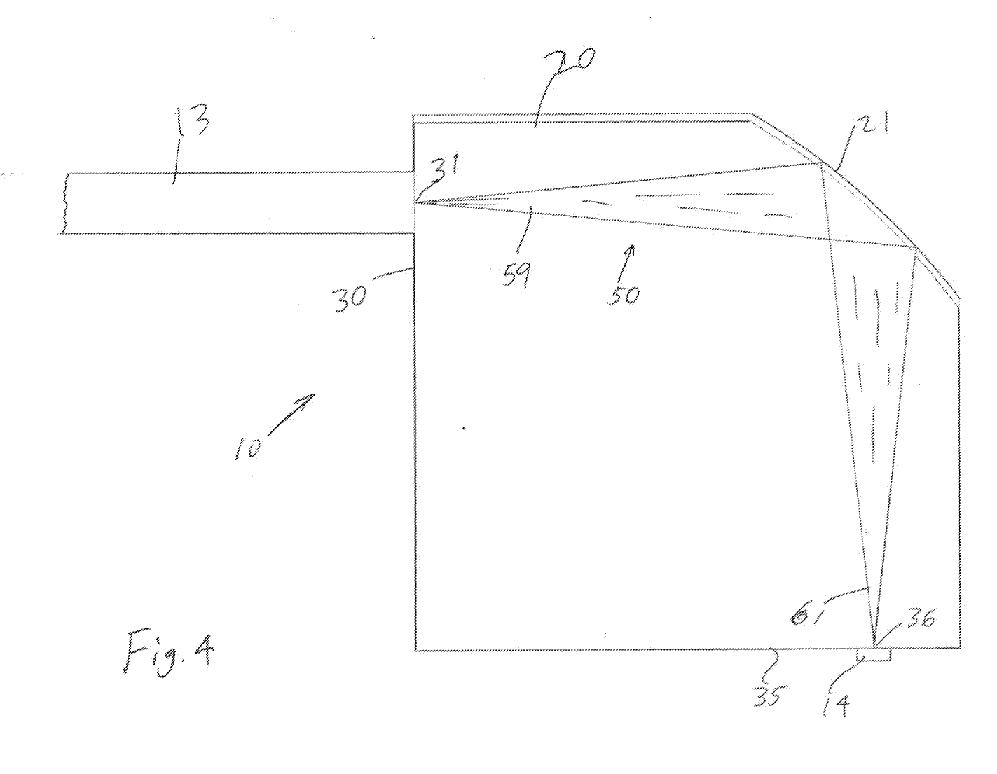

FIGS. 1-4 depict an optical coupling system 10 for optically coupling two components together. As depicted, a first optical component or optical source 11 and a second optical component or optical target 12 are optically coupled by a transparent optical coupling component 20, More specifically, coupling component 20 directs optical signals in the form of light from the first optical component 11 to the second optical component 12. In one embodiment, the first optical component 11 may be any optical source such as a semi-conductor emitter or transmitter or an optical fiber through which an optical signal is transmitted. The second optical component 12 may be any optical target such as a semi-conductor detector or receiver or an optical fiber into which an optical signal is directed.

Coupling component 20 may be a one-piece polymer or resin member that includes a reflecting surface 21 together with a first focal surface 30 spaced from and opposing the reflecting surface and a second focal surface 35 that is also spaced from and opposing the reflecting surface. The first focal surface 30 is spaced from and at an angle to the second focal surface 35. The angle between the first focal surface 30 and the second focal surface 35 may be any desired angle provided that the other characteristics of the optical component 20 as described below are met, In sonic applications, the angle between the first focal surface 30 and the second focal surface may be between approximately 70 and 110 degrees. In other application the angle may be approximately 90 degrees.

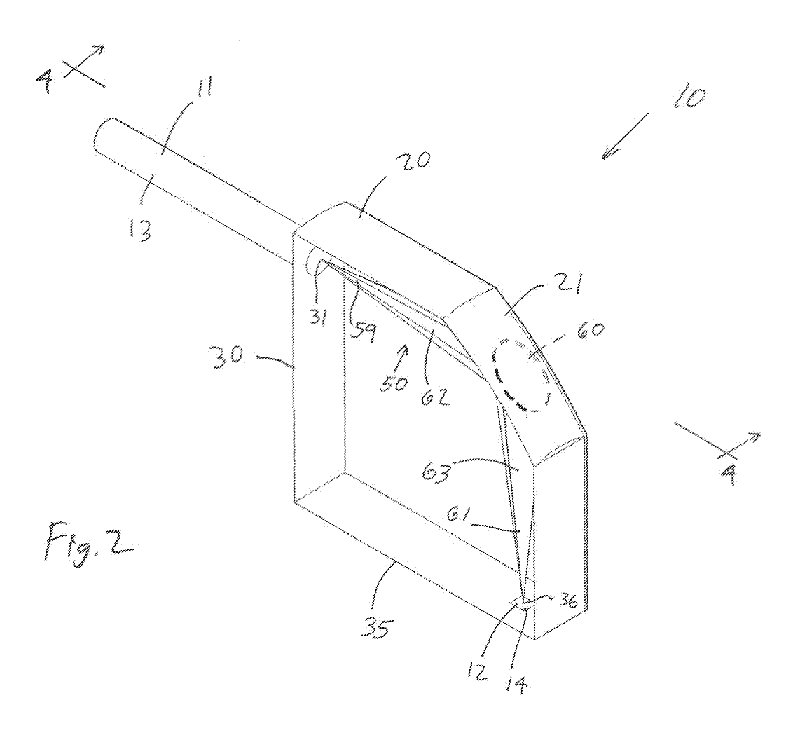

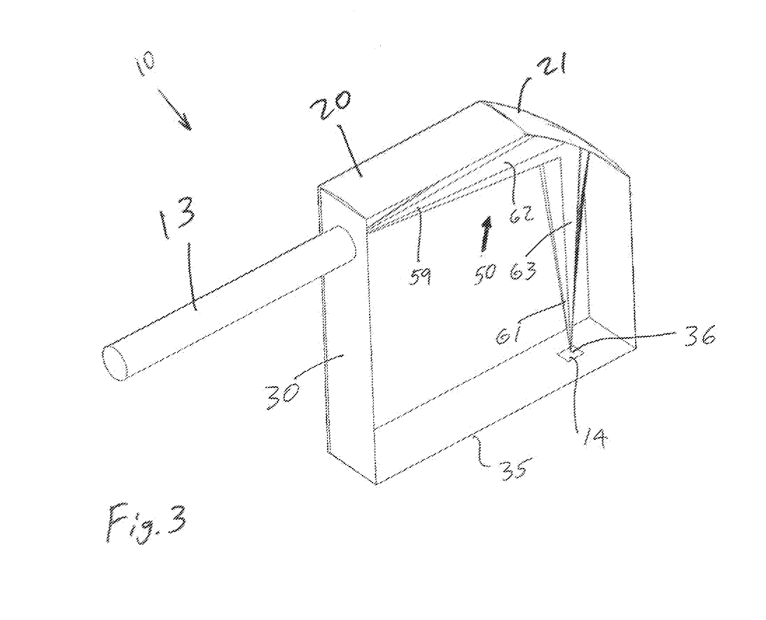

Reflecting surface 21 may have an ellipsoidal shape or surface (FIGS. 2-3) to create or define a pair of optical foci or focal points 31, 36, An ellipse defining a portion of the reflecting surface 21 is depicted in dashed line 38 for clarity. First focal point 31 may fall on or be aligned with first focal surface 30 and second focal point 36 may fall on or be aligned with the second focal surface 30. By aligning the first focal point 31 in three dimensions (x, y and z) with the first optical component 11 and second focal point 36 in three dimensions with the second optical component 12, losses within the optical coupling between the first optical component and the second optical component may be minimized.

It should be noted that in some instances, it may be desirable to only generally align the focal surfaces with the respective foci. For example, this may occur when it is desirable for the beam of light being transmitted to be focused at a specified diameter rather than a specified point or in instances in which exact alignment is not required for system performance. In such case, the light enters and exits coupling component 20 at a focal plane rather than a point.

As depicted in FIG. 1, the major axis 39 of ellipse 38 (i.e., a line through the foci) is at an angle to both the first focal surface 30 and the second focal surface 35. The angle of the major axis 39 relative to the focal surfaces coincides with the angle of the reflecting surface relative to the focal surfaces.

As depicted in FIG. 1, first focal surface 30 is configured as a source location aligned with first optical component 11 and second focal surface 31 is configured as a target location aligned with second optical component 12. As such, optical signals in the form of a beam of light may enter the first focal surface 30 at an angle generally perpendicular to the first focal surface, reflect off of the reflecting surface 21, and exit from the second focal surface 35 at an angle generally perpendicular to the second focal surface. However, the first optical component 11 and the second optical component 12 may be reversed with the coupling component 20 operating with equal effectiveness.

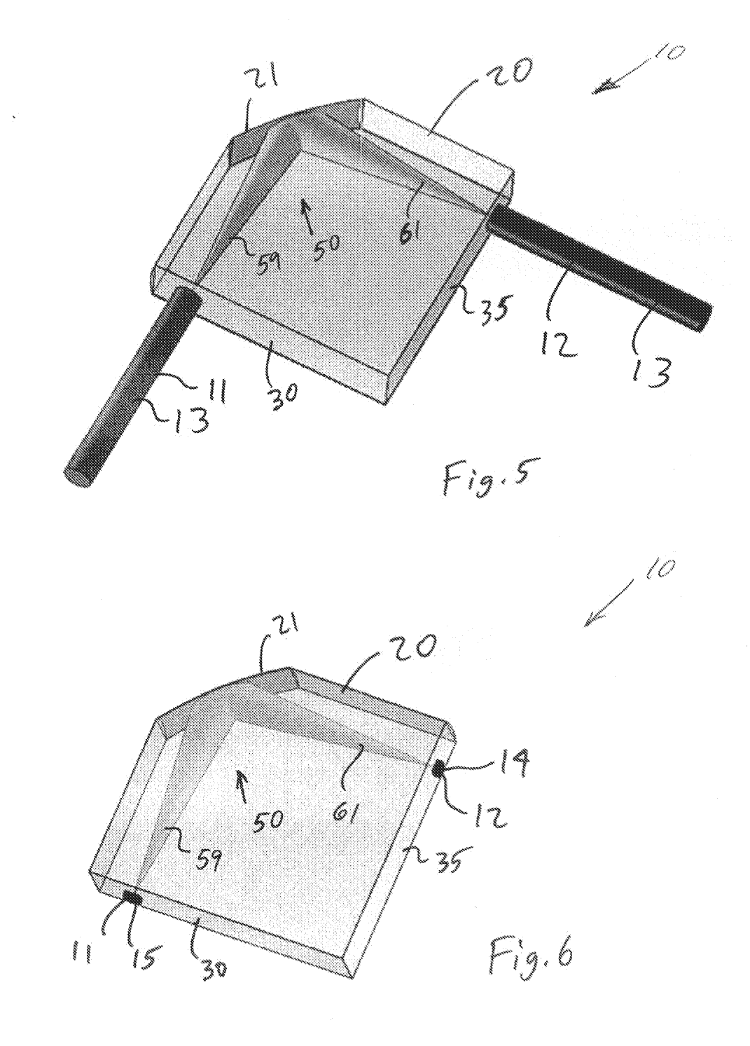

In other words, the coupling component 20 operates in an equally effective manner regardless of whether tight is being transmitted from the first focal surface 30 to the second focal surface 35 or if light is being transmitted from the second focal surface to the first focal surface. As an example, the first optical component 11 is depicted in FIG. 1 as an optical fiber 13 and second optical component 12 as a detector 14. In FIG. 5, both the first optical component 11 and the second optical component are depicted as optical fibers 13. In FIG. 6, the first optical component 11 is depicted as an emitter 15 and the second optical component is depicted as a detector 14.

Optical component 20 may be formed of an optical grade polymer that is capable of being injection molded, formed as part of an additive process (e.g., 3-D printed) or otherwise formed, such as polycarbonate, cyclic olefin or Ultem.® By positioning optical component 20 so that the reflecting surface 21 is in contact with air, the differences in the indices of refraction between the optical component and air causes light to reflect efficiently off of the reflecting surface. That is, provided that the light engages the reflecting surface at an angle greater than the Brewster angle, the ellipsoidal shaped reflecting surface 21 operates as a total internal reflecting mirror that efficiently reflects light that enters the optical component 20 at the first focal point 31 and focuses the light at the second focal point 36. As a result, light entering the optical component 20 from the first optical component 11 will reflect off of reflecting surface 21 and direct the light into second optical component 12.

As depicted in FIGS. 1-6, an optical signal transmitted through coupling component 20 may be depicted as a beam or a bundle of rays 50. A first component of the beam is depicted at 51 entering optical component 20 at a first angle generally perpendicular to first focal surface 30 at source location 30 and reflects off of reflecting surface 21 at location 22 at a first reflecting angle 52 so that the light is reflected to second focal point 36. In addition, a second component of the beam that represents one outer vertical boundary of the beam is depicted at 53 entering optical component 20 at a second entry angle 54 relative to surface 31 at source location 30 and reflects off of reflecting surface 21 at location 23 at a second reflecting angle 55 so that the light is reflected to second focal point 36. Still further, a third component of the beam that represents an opposite outer vertical boundary of the beam is depicted at 56 entering optical component 20 at a third entry angle 57 relative to surface 30 at source location 30 and reflects off of reflecting surface 21 at location 24 at a third reflecting angle 58 so that the light is reflected to second focal point 36. Thus, as the light from first optical component 11 expands as it enters optical component 20, all of the light will be reflected to the second focal point 36.

Referring to FIGS. 2-3 and 5-6, it should be understood that the beam of light 50 will expand in three dimensions to form a relative conical shape and the ellipsoidal shape of the reflecting surface will reflect the light to the second focal point 36. For example, light enters the coupling component 20 at first focal surface 30 as a relatively small collimated beam of light 59. The beam expands in three dimensions as it travels through coupling component 20 until it reaches reflecting surface 21, The beam of light will contact the reflecting surface 21 in a generally elliptical shape as depicted at 60 (FIG. 2) and reflect off of the reflecting surface.

The beam of light will taper or focus as depicted at 61 until it reaches the second focal point 36 In a manner similar to the outer vertical boundaries of the beam that are depicted at 53 and 56 (as depicted in FIG. 1), the lateral or horizontal expansion of the beam of light will also be redirected by the ellipsoidal reflecting surface 21 to the second focal point 36. One lateral outer boundary of the beam of light 50 as it expands is depicted in FIGS. 2-3 at 62 and a lateral outer boundary as the beam of light contracts or is focused is depicted at 63.

Under ideal operating conditions, reflecting surface 21 operates as a total internal reflecting mirror due to the shape of the surface and the difference in the indices of refraction between the optical coupling component 20 (optical grade polymer) and the atmosphere (air) surrounding the reflecting surface. However, if a contaminant or foreign material (e.g., water, dirt, dust, adhesive) is in contact with the outer surface 25 of the reflecting surface 21, such undesired material will change the difference in the indices of refraction between the optical component 20 and the air at the location of the contaminant and thus change the optical characteristics of the reflecting surface at the contaminant.

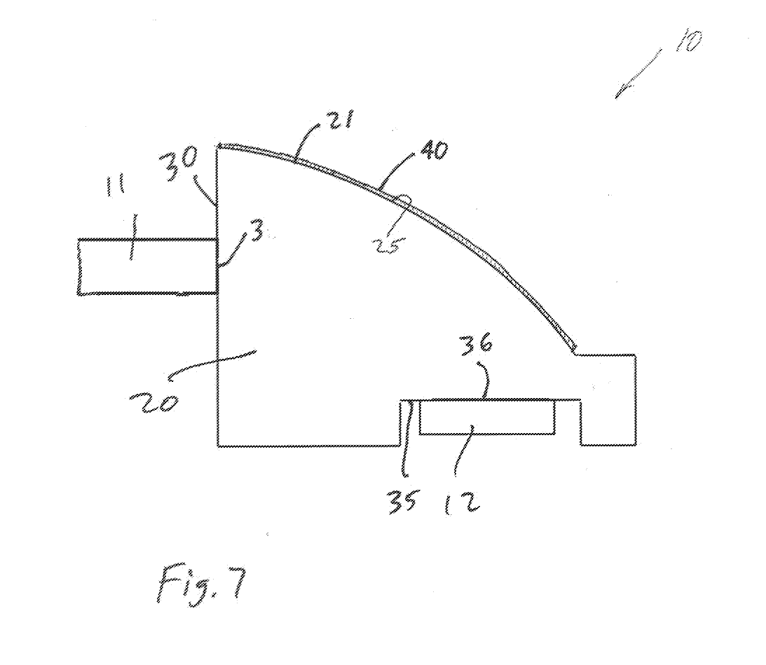

In order to reduce the risk of such a change in the reflecting characteristics of the reflecting surface 21, and a corresponding change in the performance of coupling component 20, it may be desirable to add or apply a reflective coating or plating 40 (FIG. 7) to the outer surface 25 of the optical component 20 along the reflecting surface 21. The coating 40 provides additional reflectivity in case any contaminants or foreign materials come into contact with or become affixed to the outer surface of the reflecting surface. The reflective coating 40 may be any highly reflective material such as gold, silver, or any other desired material. Coating 40 may be applied to the outer surface 25 in any desired manner. Although depicted with the coating 40 extending along the entire reflecting surface 21, the coating may be selectively applied so that it is only applied in the portion of the reflecting surface at which most of the beam of light will reflect.

Upon assembling optical coupling system 10, an index matched medium 41 may be used to fill a first gap 16 (FIG. 1) between the first optical component 11 and the first focal surface 30 of coupling component 20 and a second gap 17 between the second optical component 12 and the second focal surface 35 of the optical component. It should be noted that FIG. 1 is not to scale for purposes of illustration. The gaps 16, 17 may be any desired distance, In one example, the gaps 16, 17 may be between 25 and 50 microns.

The refractive index of the medium 41 may closely match the refractive indices of the first optical component 11, the second optical component 12, and the coupling component 20. The medium 41 may be an index matched adhesive such as an epoxy that not only transfers light between the first optical component 11, the second optical component 12, and the coupling component 20 in an efficient manner but also functions to secure the first optical component 11 and the second optical component 12 to the coupling component 20.

In an alternate embodiment, the first optical component 11 and the second optical component 12 may be secured to the coupling component 20 using some structure or mechanism other than an adhesive and the medium 41 may be an index matching gel, fluid or other material that does not have adhesive qualities.

The index of refraction of the medium 41 may be any desired value. In one example, the index of refraction of silica optical fiber is approximately 1.48 and the index of refraction of the polymer coupling component 20 is approximately 1.56. In such case, the index of refraction of the medium 41 may be matched to approximate the midpoint (i.e., approximately 1.52) between the indices of refraction of the optical fibers and the coupling component 20. In another example, the index of refraction of the medium 41 may be set to be approximately equal to the index of refraction of either the optical fibers or the coupling component 20. In still another example, the index of refraction of the medium 41 may be set at any value between the indices of refraction of the optical fibers and the coupling component 20. Regardless of the medium, the use of an index matched medium will generally result in improved optical characteristics within the system 10.

The coupling component 20 provides the advantage of redirecting and focusing an optical signal from the first optical component 11 to the second optical component without transmitting the signal through air and thus reduces the impact of changes in temperature on the signal transmission. More specifically, as the signal travels through the coupling component (i.e., from the first foci 31 to the reflecting surface 20 and from the reflecting surface to the second foci 36), it is subject to a constant index of refraction along its entire path since it is always traveling though the polymer material, Still further, the components other than the coupling component 20 that form the optical path of system 10 (i.e., first optical component 11, second optical component 12 and medium 41), have very similar indices of refraction and thus changes in temperature have a relatively small impact. By closely matching the indices of refraction of the first optical component 11, the second optical component 12, the coupling component 20, and the medium 41 and avoiding the transmission of the signal through air, the impact of changes in the index of refraction due to changes in temperature and resulting degradation in the optical signal may be minimized.

By reducing the impact of temperature change with respect to the refractive index, the beam of light or optical signal is consistently focused on the target location. While this may be desirable in most applications, it may be especially important when one or both of the first optical component 11 and the second optical component 12 are single mode optical fibers due to their relatively small core diameter as compared to that of a multi-mode optical fiber.

The shape of the coupling component 20 may also provide the benefit of compensating to some extent for changes in the physical structure of the coupling component due to expansion and contraction with changes in temperature. More specifically, due to the elliptical shape of the reflecting surface 21, the position of the first focal point 31 and the second focal point 36 will typically follow the position of the first optical component 11 and the second optical component 12, respectively, as the coupling component 20 changes size with changes in temperature.

While a preferred embodiment of the Present Disclosure is shown and described, it is envisioned that those skilled in the art may devise various modifications without departing from the spirit and scope of the foregoing Description and the appended Claims.

What is claimed is:

1. An optical interconnect assembly, the optical interconnect assembly comprising:
an optical coupling component having a body formed of a polymer material, the body having an ellipsoidal reflecting surface defining a first focal point and a second focal point, a first focal surface generally aligned with the first focal point, a second focal surface generally aligned with the second focal point, the first focal surface and the second focal surface being spaced apart and at an angle to each other, and an optical path extending through the body from the first focal point to the reflecting surface and to the second focal point;
an optical source from which a light signal is transmitted, the optical source being positioned adjacent the first focal surface; and
an optical target at which the light signal is received, the optical target being positioned adjacent the second focal surface.

2. The optical interconnect assembly of claim 1, wherein the angle of the first focal surface relative to the second focal surface is between approximately 70 and 110 degrees.

3. The optical interconnect assembly of claim 1, wherein the angle of the first focal surface relative to the second focal surface is approximately 90 degrees.

4. The optical interconnect assembly of claim 1, wherein the optical source is positioned relative to the first focal surface so that an optical signal enters the optical coupling component at the first focal surface generally perpendicular to the first focal surface and the optical target is positioned relative to the second focal surface so that an optical signal exits the optical coupling component at the second focal surface generally perpendicular to the second focal surface.

5. The optical interconnect assembly of claim 1, wherein at least one of the optical source and the optical target is a single mode optical fiber.

6. The optical interconnect assembly of claim 1, wherein the optical source is an emitter.

7. The optical interconnect assembly of claim 1, wherein the optical target is a detector.

8. The optical interconnect assembly of claim 1, wherein a first gap exists between the optical source and the first focal surface, a second gap exists between the optical target and the second focal surface, and an index matched medium is positioned within each gap.

9. The optical interconnect assembly of claim 8, wherein the optical coupling component has a refractive index of about 1.56 and the index matched medium has a refractive index of about 1.52.

10. The optical interconnect assembly of claim 8, wherein the index matched medium fills each gap.

11. The optical interconnect assembly of claim 1, wherein the entire optical path s through the polymer material.

12. The optical interconnect assembly of claim 1, wherein an outer surface of the body adjacent the reflecting surface has a reflective coating thereon.

13. The optical interconnect assembly of claim 12, wherein the reflective coating is chosen from one of gold, silver and a gold alloy.

14. The optical interconnect assembly of claim 1, wherein the first focal surface intersects with the first focal, point and the second focal surface intersects with the second focal point.

15. An optical coupling component for optically coupling a first optical component to a second optical component, comprising:
a body formed of a polymer material, the body having:
an ellipsoidal reflecting surface defining a first focal point and a second focal point,
a first focal surface aligned with the first focal point;
a second focal surface aligned with the second focal point, the first focal surface and the second focal surface being spaced apart and at an angle to each other; and
an optical path extending through the body from the first focal point to the reflecting surface and to the second focal point.

6. The optical coupling component of claim 15, wherein the entire optical path is through the polymer material.

17. The optical coupling component of claim 15, wherein an outer surface of the body adjacent the reflecting surface has a reflective coating thereon.

18. The optical coupling component of claim 7, wherein the reflective coating is chosen from one of gold, silver, and a gold alloy.

19. The optical coupling component of claim 15, wherein the first fiscal surface intersects with the first focal point and the second focal surface intersects with the second focal point.

20. An optical interconnect assembly comprising:
an optical coupling component having a body formed of a polymer material, the body having a reflecting surface defining a first focal point and a second focal point, a first focal surface generally aligned with the first focal point, a second focal surface generally aligned with the second focal point, the first focal surface and the second focal surface being spaced apart and at an angle to each other, and an optical path extending through the body from the first focal point to the reflecting surface and to the second focal point;
an optical source, the optical source being positioned adjacent the first focal surface; and
an optical target, the optical target being positioned adjacent the second focal surface.
